(19) United States
(12) Patent Application Publication
(10) Pub. No.: US 2017/0128305 A1
(43) Pub. Date: May 11, 2017

(54) CUSTOMIZED URNS AND METHODS FOR MANUFACTURING SAME

(71) Applicant: Foreverence LLC, Maple Grove, MN (US)

(72) Inventors: Peter Saari, Maple Grove, MN (US); Noah Miwa, New Brighton, MN (US)

(21) Appl. No.: 15/347,264

(22) Filed: Nov. 9, 2016

Related U.S. Application Data
(63) Continuation-in-part of application No. 29/545,018, filed on Nov. 9, 2015.
(60) Provisional application No. 62/252,859, filed on Nov. 9, 2015.

(51) Int. Cl. A61G 17/08

(52) U.S. Cl. CPC A61G 17/08

(57) ABSTRACT

Completely customized urns may be manufactured using additive manufacturing technology and techniques by taking customer-providing information, generating a computer file based on the customer-provided information, printing a customized urn with an inner surface that defines a cavity with an opening, and applying a hardening agent. A sealing mechanism is provided to close the opening. In at least one embodiment, the cavity is sloped.

### CROSS-REFERENCE TO RELATED APPLICATIONS

This application claims priority to U.S. Provisional App. No. 62/252,859, titled “Customized Urns and Methods for Manufacturing Same,” filed Nov. 9, 2015, the contents of which are hereby incorporated by reference herein in their entirety. The application claims priority to U.S. Design Pat. App. No. 29/545,018, titled “Urn in the Shape of a Book,” filed Nov. 9, 2015, the contents of which are hereby incorporated by reference herein in their entirety.

### FIELD OF THE INVENTION

The present disclosure relates to novel and advantageous urns which are customized to an individual's or group's specification and methods for manufacturing the same.

### BACKGROUND OF THE INVENTION

Cremation is growing in popularity as an end of life choice for humans and pets. 2015 marks the first time in U.S. history that cremation has surpassed burial for humans. The act of cremation results in remains (largely ash) which, in whole or in part, may be retained in some sort of container or “urn.” Urns are well known for retaining the cremated remains of humans and pets and have been described at least in connection with U.S. Pat. No. 7,562,423; U.S. Pat. No. 8,196,274; U.S. Pat. No. 6,785,938; and U.S. Pat. No. 4,324,026, which are each incorporated herein by reference in their entireties.

Dating back centuries, retaining cremated remains has been a common practice for humans. Remains are typically stored in a vessel or chamber that is often displayed or buried as religious ritual, an act of reverence or to honor the life it represents. Despite the unique life that the urn holds, personalization of urns has been largely limited to simple elements such as color or inscription details applied to the urn. Further, the urn itself has been nearly exclusively created in the shape of a rectangular or cylindrical shape (e.g. box or vase) with a sealing mechanism.

However, these existing urns have several deficiencies. They lack variety of shape, color, personalization and fully customized or unique urn options. Even those urns marketed as “custom” are typically handmade, which takes a significant amount of time and expense to create, and thus are often too costly for general consumer use. The disclosed inventions herein correct these deficiencies by allowing for total customization of an urn while manufacturing the product more quickly and at less overall expense.

### BRIEF SUMMARY OF THE INVENTION

The present disclosure relates to customized urns and methods of manufacturing the urns using additive manufacturing technology and techniques (also called “3D printing”). By using additive manufacturing, complete customization of the urn is achievable.

In at least one embodiment, a customized urn comprises a printed outer surface defined by customer-provided information; an inner surface defining a cavity; a wall thickness between the outer surface and the inner surface; an opening in communication with the cavity; a sealing mechanism for closing the opening. The customized urn may further comprise a hardening agent applied to at least one of the printed outer surface and the inner surface. In some embodiments, at least a portion of the inner surface defining a cavity is a sloped surface to aid at least with removal of excess hardening agent. The printed outer surface may define a desired shape, which may include, for instance, a car or a book having a spine. In some embodiments, the customized urn may further comprise at least one component permanently or removably attached to the printed outer surface. In at least one embodiment, the at least one component may be attached to the printed outer surface by magnets disposed within the at least one component and the printed outer surface. In some embodiments, the wall thickness may comprise at least a first layer defining the printed outer surface and a second layer defining the inner surface. The second layer may have a thickness greater than the first thickness. In some embodiments, the wall thickness may further comprise a third layer between the first layer and the second layer. The third layer may have a density less than a density of the second layer. In some embodiments, the customized urn further comprises at least one interior structure support spanning the cavity between a first portion of the inner surface and a second portion of the inner surface. In some embodiments, the sealing mechanism may comprise a locking mechanism.

In some embodiments, a method of manufacturing a customized urn comprises obtaining a customer specification with a desired shape of the customized urn; generating a computer file based on the desired shape; determining an outer surface, an inner surface, a thickness between the outer surface and the inner surface, and cavity based on the desired shape; printing layers of material to form at least the outer surface and the inner surface; and applying a hardening agent to at least one of the outer surface and the inner surface. In some embodiments a computer file may be generated based on at least the customer specification, but may also include other customer-provided information. In some embodiments, the method may further comprise applying a paint layer to the outer surface. In some embodiments, the method may further comprise allowing the hardening agent to cure. In some embodiments, the method may further comprise removing excess hardening agent from the cavity.

### BRIEF DESCRIPTION OF THE DRAWINGS

FIG. 1 is a schematic view of the custom manufacturing process, in accordance with at least one embodiment of the present disclosure.

FIG. 2 is a perspective view of a customized urn, in accordance with at least one embodiment of the present disclosure.

FIG. 3 is a bottom view of the customized urn of FIG. 2, in accordance with at least one embodiment of the present disclosure.

FIG. 4 is a cross-sectional view of the urn of FIG. 2, in accordance with at least one embodiment of the present disclosure.

FIG. 5 is a perspective view of a customized urn, in accordance with at least one embodiment of the present disclosure.

FIG. 6 is a bottom view of the customized urn of FIG. 5, in accordance with at least one embodiment of the present disclosure.

FIG. 7 is a cross-sectional view of the urn of FIG. 5, in accordance with at least one embodiment of the present disclosure.

FIG. 8 is a perspective view of a customized urn, in accordance with at least one embodiment of the present disclosure.

FIG. 9 is a bottom view of the customized urn of FIG. 8, in accordance with at least one embodiment of the present disclosure.

FIG. 10 is a cross-sectional view of the urn of FIG. 8, in accordance with at least one embodiment of the present disclosure.

### DETAILED DESCRIPTION

The present disclosure describes customized urns and techniques for manufacturing the customized urns using additive manufacturing processes. This described invention is a single, customized vessel or article including one or multiple cavities comprised of a ceramic composite produced using an additive manufacturing process. The vessel may originate as multiple pieces during the manufacturing stage, however, the completed article culminates in a single unit that may include a closure mechanism or other detachable features. The invention is intended for use as a cremation urn which holds, in total or in part, the cremated remains of one or multiple humans or pets, however, housing remains is not a requirement of this invention.

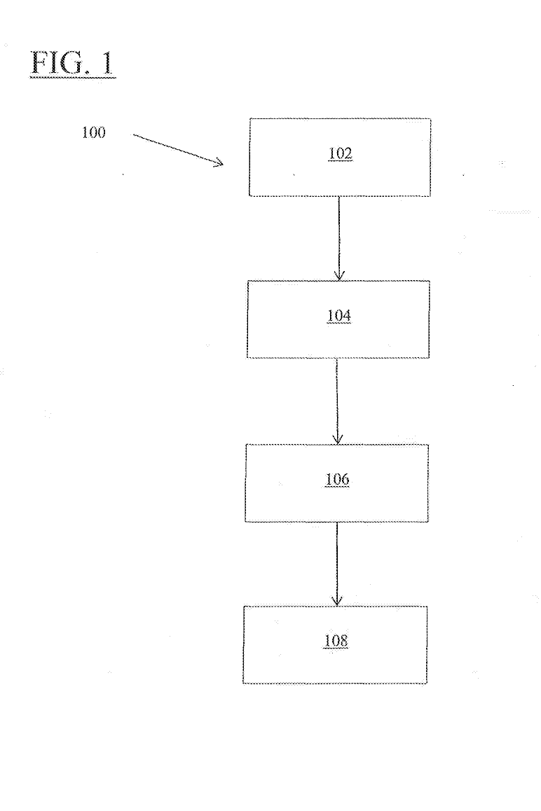

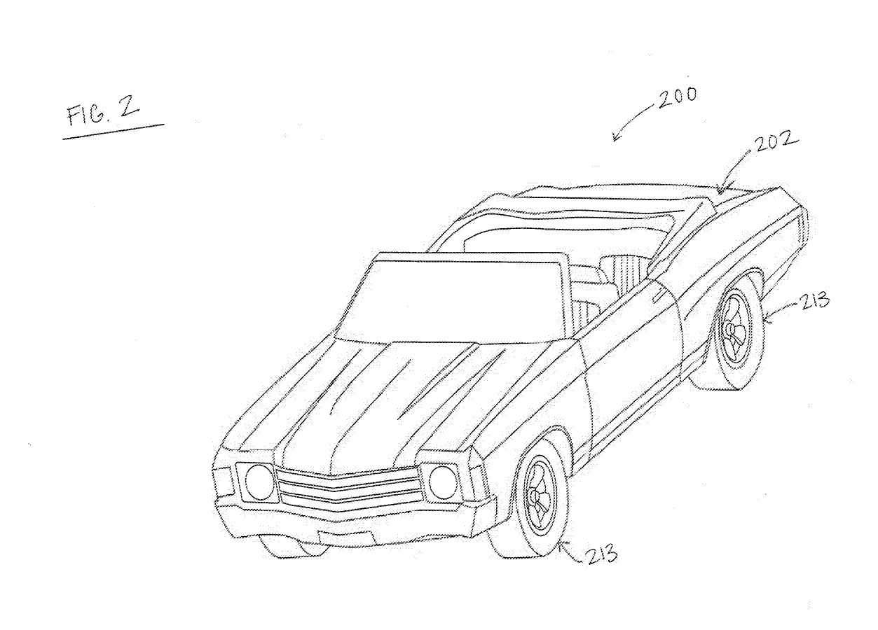

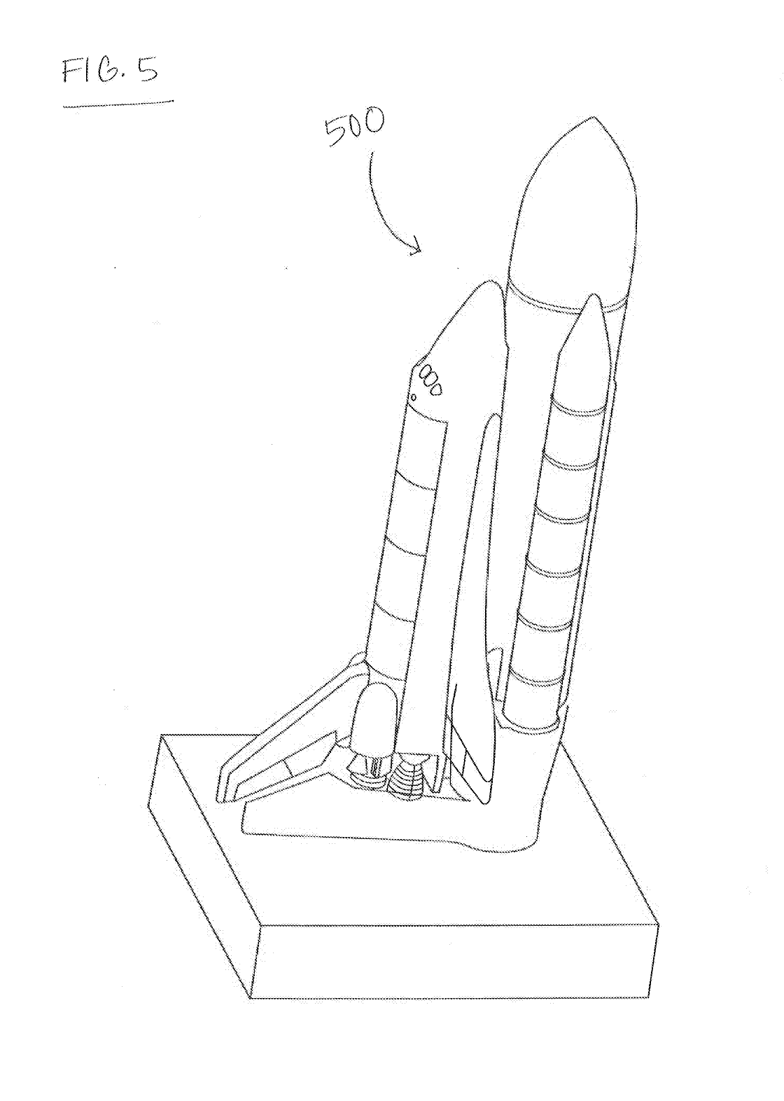

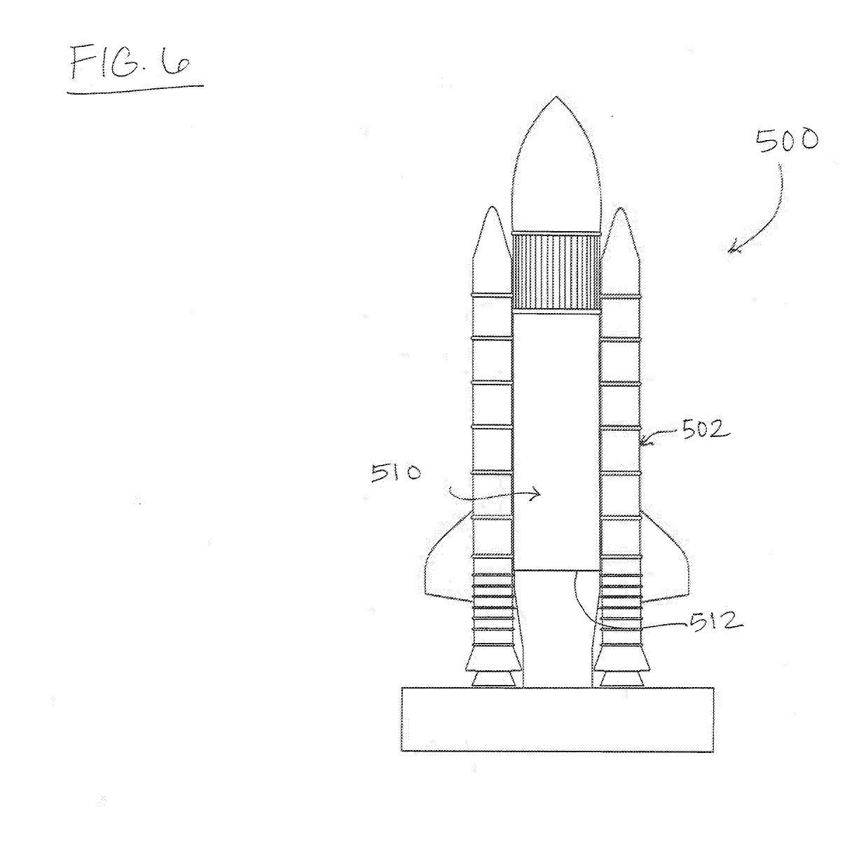

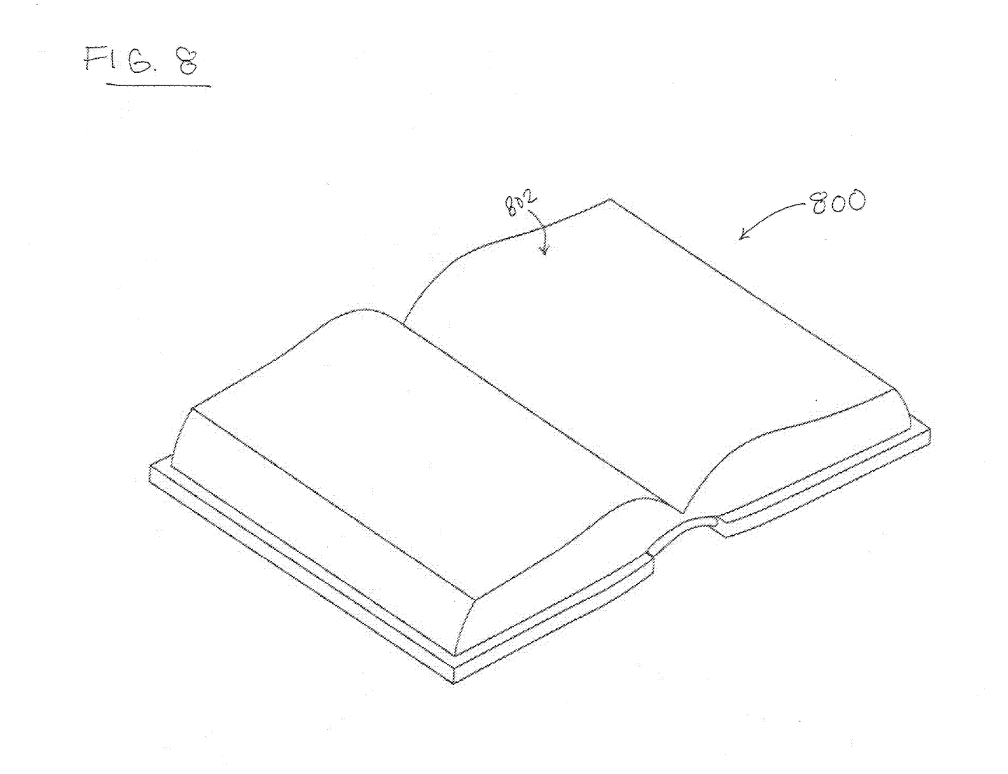

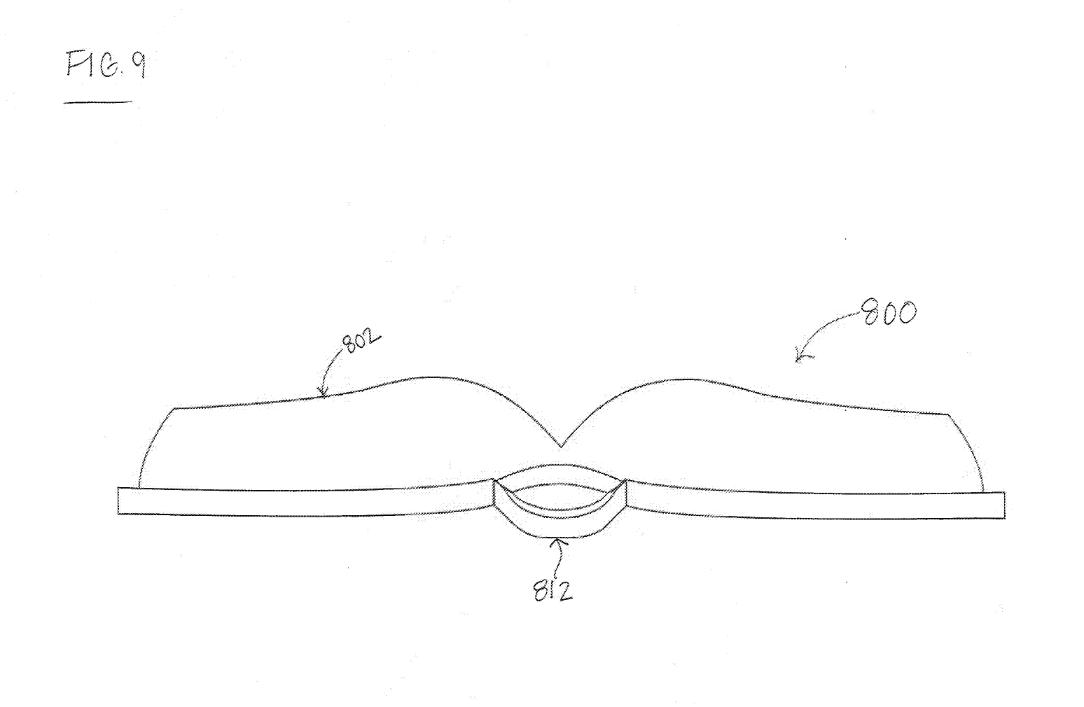

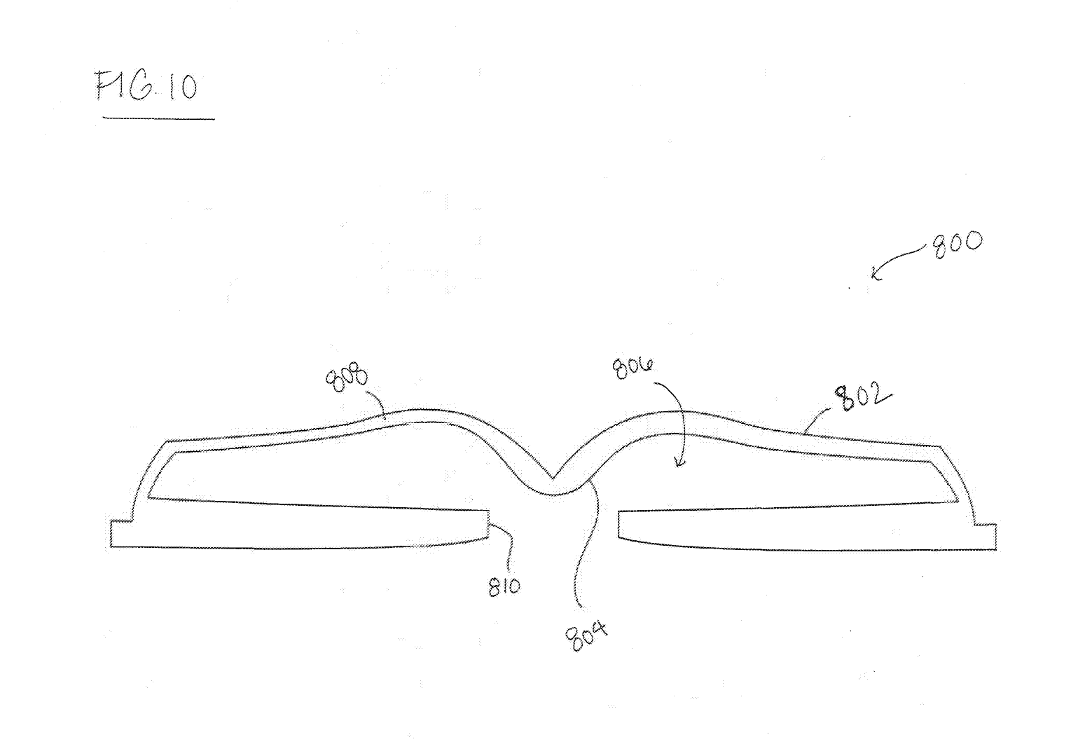

The creation of a customized urn to a customer specification includes the process by which the urn's design is developed. FIG. 1 shows one embodiment 100 of the method for manufacturing a customized urn to a customer specification using additive manufacturing processes. The customer specification may include at least one or more of the following: a desired shape; size; orientation; color(s); text or image(s) that are desired to be embossed, debossed, surface printed or etched into a surface; number of cavities; or other specifications for the customized urn. Importantly, the shape, size, orientation and color(s) of the article are variable and customizable. For instance, the customer specification may reference the desired shape, which may be any shape including a car (as shown in FIGS. 2-4), a space shuttle (as shown in FIGS. 5-7), and a book (as shown in FIGS. 8-10) or other objects such as, but not limited to, animals, instruments used for a hobby or trade, articles of clothing, landmarks, buildings, artistic works, symbolic artifacts, historical artifacts, cultural artifacts, heirlooms, or uniquely designed shapes. As shown at 102, customer-provided information is obtained related to the customer specification. This customer-provided information may include one or more of the following: photographs, digital images, digital files, physical objects, verbal description, written description, or two- or three-dimensional computer files. In some embodiments, the desired shape may be rendered wholly from the customer-provided information. In some embodiments, the desired shape may be a uniquely designed three-dimensional shape derived from at least some of the customer-provided information. At least one three-dimensional computer file is then created from the customer specification and the customer-provided information, in whole or in part, as shown at 104. In some embodiments, the three-dimensional computer file is in a required format such as .wrl or .stl. The three-dimensional computer files may include the three dimensional components of the article and color texture, which, if included in the customized urn design, may be printed as a part of the urn's production in lieu of being adhered, inserted, or otherwise applied after the three-dimensional printing process is complete. The inclusion of color texture may provide the full spectrum of colors to be printed on the article, allowing for fine detail and customizable elements akin to a photo image.

The customized urn can then be printed using an additive manufacturing process as shown at 106. In at least one embodiment, the manufacturing process utilized includes the depositing of a binding material and colored ink onto a bed of ceramic powder or similar material in layer by layer fashion. Once the final layer indicated in the computer file has been applied, the printing portion of manufacturing is complete. In at least one embodiment, once finished, any excess material may be removed and urn is allowed to dry. After drying, in at least one embodiment, the external surfaces are sanded. In at least one embodiment, as shown at 108, a hardening agent (such as a cyanoacrylate compound, epoxy or similar) is applied to at least one of the outer surface and the inner surface either through topical application or submersion to harden the composite. In some embodiments, the hardening agent is applied to both the outer surface and the inner surface and allowed to cure or dry. In at least one embodiment, at least one enamel-based paint layer may be applied to the outer surface of the customized urn. The paint layer may comprise a material comprising a UV protectant, pigment, light-reflective of various surface finish qualities including but not limited to gloss, satin or matte finishes.

FIGS. 2-4 show one embodiment of a customized urn 200 manufactured utilizing the process described herein. In FIGS. 2-4, the customized urn 200 is in the shape of a car. Customized urn 200 comprises an outer surface 202 defined by customer-provided information; an inner surface 204 defining a cavity 206; a thickness 208 between the outer surface and the inner surface; an opening 210 in communication with the cavity 206; and a sealing mechanism 212 for closing the opening 210. In some embodiments, customized urn 200 further comprises components 213 which may be adhered, mounted, or otherwise attached to the outer surface 202 after printing. For example, on the car-shaped customized urn 200, the wheels 213 may be later mounted to the outer surface of the printed urn. Components 213 may be printed using additive manufacturing techniques, or they may be created using other manufacturing techniques such as injection molding. In some embodiments, the components 213 are removable and not permanently attached. In such cases, the removable components may have a magnet that attach to magnets disposed in the outer surface of the urn.

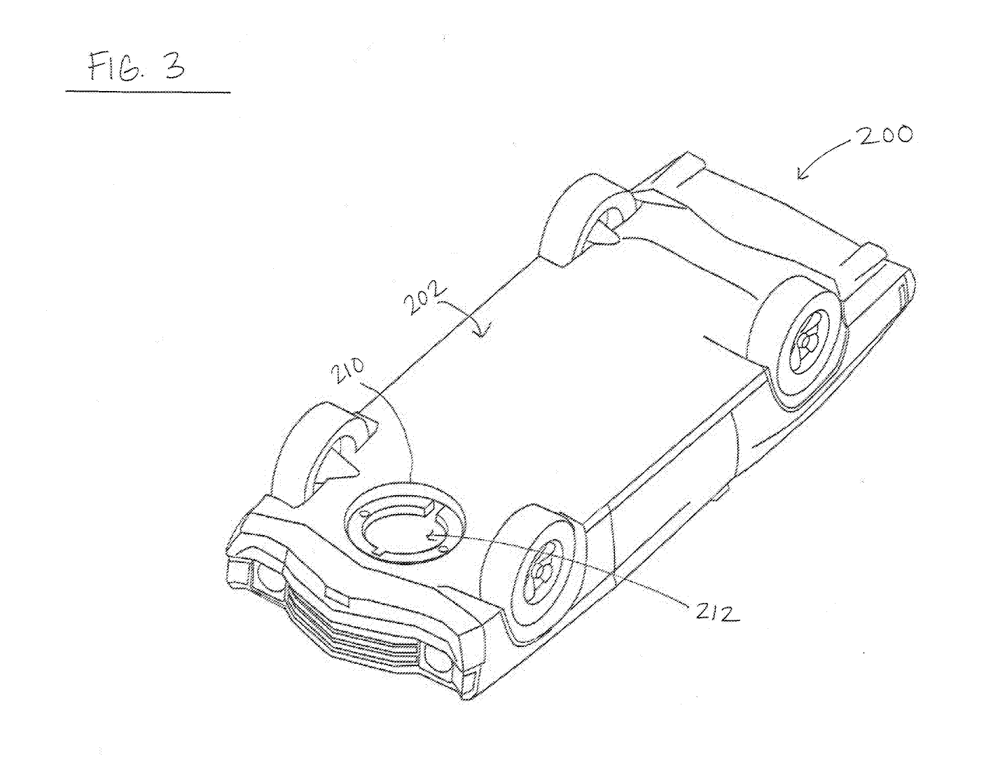

FIG. 3 shows one embodiment of a sealing mechanism 212 for closing the opening 210. In most embodiments, the sealing mechanism 212 is separately manufactured from the rest of the customized urn 200 and may be may be printed using additive manufacturing techniques, or they may be created using other manufacturing techniques such as injection molding. The sealing mechanism 212 may have an outer surface 216 having the same color and/or surface texture as the outer surface of the urn nearest the opening 210. In at least the embodiment shown of the sealing mechanism 212, the sealing mechanism 212 has a handle feature on an exterior surface of the sealing mechanism. The sealing mechanism 212 may also comprise at least one locking feature on a side surface of the sealing mechanism 212, with a matching locking feature on an inner surface of the opening 210. In at least one embodiment, to seal the opening 210 of the customized urn, the sealing mechanism is turned until the locking feature of the sealing mechanism completely connects with the matching locking feature on the opening.

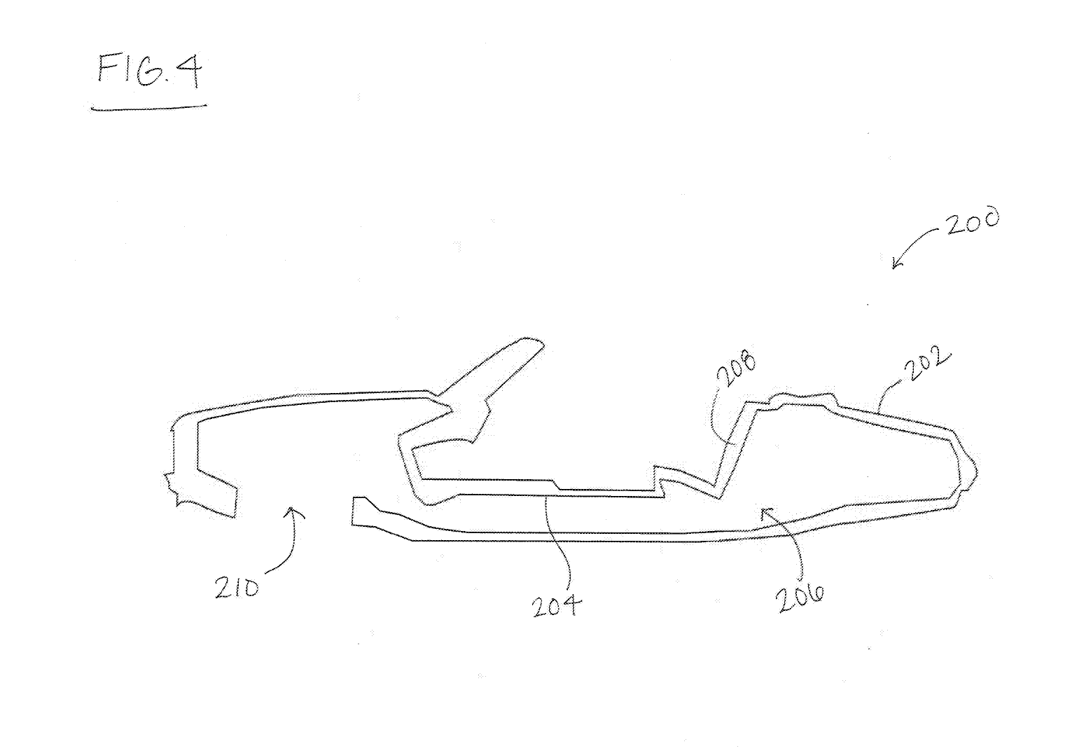

Although as shown in FIG. 4, one cavity 206 is used, the urn may have more than one cavity, each cavity being defined by at least a portion of the urn wall, and specifically defined by an inner surface of the urn.

In some embodiments, the wall thickness 208 is comprised of at least two layers employed with a three-dimensional, additive manufacturing. In some embodiments, the wall thickness 208 comprises three layers. The exterior surface layer which defines outer surface 202 is considered the shell and, in some embodiments, particularly where the exterior surface layer comprises a ceramic material, measures between about 0.03 inches and 0.04 inches (0.8 millimeters to 1.1 millimeters). This shell is achieved when a color texture file surrounds the model image. The shell may be printed in monochrome or full color pigment based on the customer specification and customer-provided information. The second layer is considered a core layer, and, in some embodiments, particularly where the core layer comprises a ceramic material, the second layer measures between 0.04 inches and 0.08 inches (1.0 millimeters to 2.0 millimeters). In some embodiments, the second layer defines the inner surface 204. In some embodiments, a third layer is provided. The third layer, which in such embodiments defines inner surface 204, may be considered the high density core layer and is the densest element of the printed article. In some embodiments, particularly where the third layer comprises a ceramic material this third layer, is only created when the combination of the first layer and the second layer exceed a thickness of about 0.20 and 0.24 inches (5.0 millimeters and 6.0 millimeters) in combination.

In at least one embodiment, particularly where the urn is made from a ceramic material, the wall thickness 208 is at least 0.25 inches (6.3 millimeters) to ensure structural integrity during the manufacturing process while keeping manufacturing costs low. In some embodiments, particularly where the urn is made from a ceramic material, the thickness 208 is in the range between 0.24 inches (6.0 millimeters) and 0.39 inches (10.0 millimeters). In one embodiment, particularly where the urn is made from a ceramic material, the thickness 208 has a preferred thickness of 0.25 inches (6.3 millimeters) in consideration of the structural integrity and material usage of the urn. It is within the scope of this invention that different wall thicknesses may be contemplated, as appropriate, depending on the material selected.

In at least one embodiment as shown in FIG. 4, cavity 206 has sloped surface 214. Sloping of the surface of the interior cavity strengthens interior surface joints and expedites the removal of excess material (which may include excess hardening material). For any article where a surface including a closure includes a flat plane, that interior surface is sloped toward the closure opening at a minimum angle of 10 degrees in some embodiments. In some embodiments, the sloped surface 214 has an angle in the range of 7 degrees to 12 degrees. In at least one embodiment, the sloped surface 214 has a preferred angle of 10 degrees.

FIGS. 5-7 show one embodiment of a customized urn 500 manufactured utilizing the process described herein. The customized urn 500 as shown in FIG. 5 is in the shape of a space shuttle having an orbital-shaped structure, a tank-shaped structure, and two booster-shaped structures. In some embodiments, these structures may be adhered, mounted, or otherwise attached to the outer surface of the urn. Customized urn 500 comprises an outer surface 502 defined by customer-provided information; an inner surface 504 defining a cavity 506; a thickness 508 between the outer surface and the inner surface; an opening 510 in communication with the cavity 506; and a sealing mechanism 512 for closing the opening 510. In at least the embodiment shown herein, the sealing mechanism 512 for closing the opening 510 is within at least tank-shaped portion of shuttle, but it may be in other positions. In at least one embodiment, the sealing mechanism 512 comprises at least one locking feature on a side surface of the sealing mechanism 512, with a matching locking feature on an inner surface of the opening 510. In at least one embodiment, to seal the opening 510 of the customized urn, the sealing mechanism is turned until the locking feature of the sealing mechanism completely connects with the matching locking feature on the opening 510.

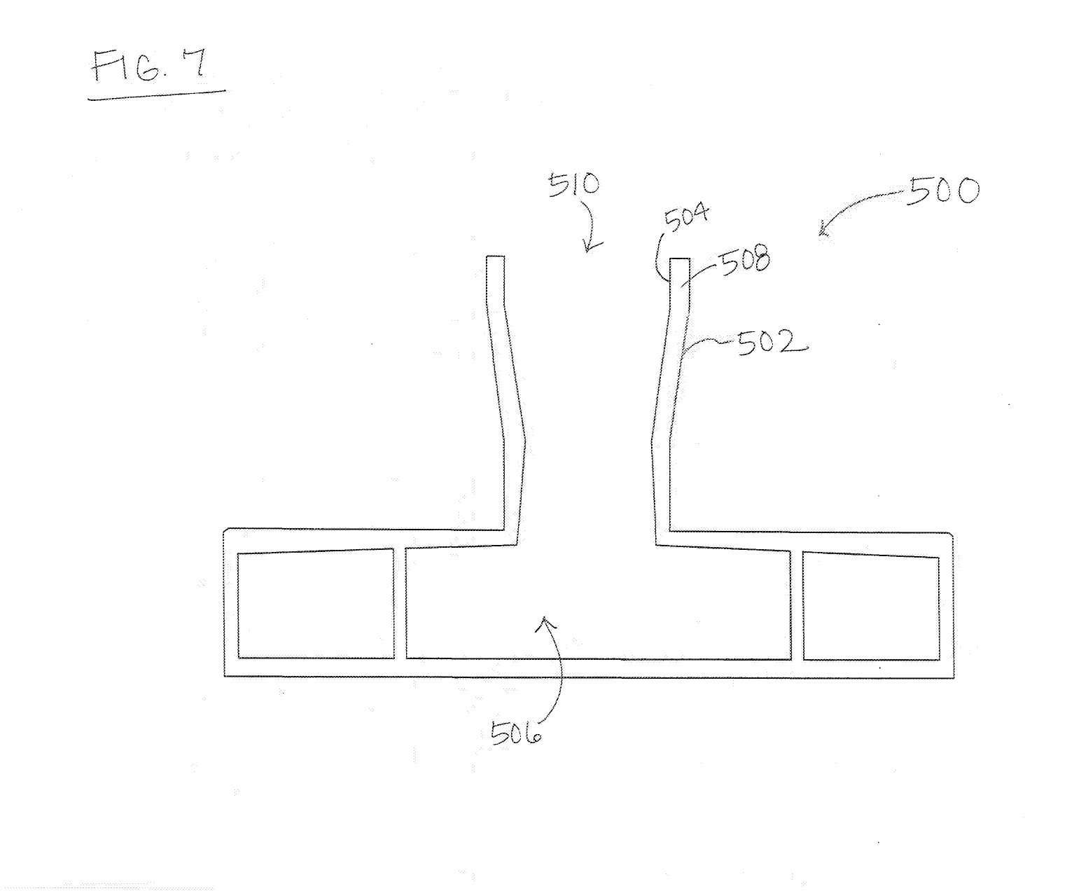

In some embodiments, as shown in FIG. 7, interior structure supports 514 may be necessary to span portions of the cavity between one portion of the inner surface and another portion for the structural integrity of the urn. In some embodiments, interior structure supports may be necessary for at least one or more of the following reasons (a) a section spans in excess of 6.0 inches (152.0 millimeters) without support, (b) where the weight of any design elements resting on or incorporated within the top of the plane exceeds a particular load of compressive force (e.g. 60 psi for a ceramic powder), (c) where the potential force of a vertical element on the top plane exerts more than a critical shear force against the plane (e.g. 20 psi for a ceramic powder), or (d) the expected remains to be placed inside the cavity(ies) exceed a desired internal tension load (e.g. 60 psi for a ceramic powder). Other reasons for requiring the interior structure supports in order to maintain the structural integrity of the urn are contemplated by this invention.

FIGS. 8-10 show one embodiment of a customized urn 700 manufactured utilizing the process described herein. The customized urn 700 as shown in FIGS. 8-10 is in the shape of a book. The customized urn 700 comprises an outer surface 702 defined by customer-provided information; an inner surface 704 defining a cavity 706; a thickness 708 between the outer surface and the inner surface; an opening 710 in communication with the cavity 706; and a sealing mechanism 712 for closing the opening 710. In at least the embodiment shown herein, the sealing mechanism 712 for closing the opening 710 is within the spine of the book but may be in other positions. In some embodiments, the sealing mechanism 712 closes the opening 710 with a frictional engagement between the mating surfaces of the sealing mechanism 712 and the inner surface of the opening 710. In some embodiments, magnets are disposed on a side surface of the sealing mechanism and engage with magnets on an inner surface of the opening 710.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

Upon reading this disclosure, those skilled in the art will appreciate still additional alternative structural and functional designs for the customized urn. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. A customized urn comprising:
a printed outer surface defined by customer-provided information;
an inner surface defining a cavity;
a wall thickness between the outer surface and the inner surface;
an opening in communication with the cavity;
a sealing mechanism for closing the opening.

2. The customized urn of claim 1, further comprising a hardening agent applied to at least one of the printed outer surface and the inner surface.

3. The customized urn of claim 1, wherein at least a portion of the inner surface defining a cavity is a sloped surface.

4. The customized urn of claim 1, wherein the printed outer surface defines a book having a spine.

5. The customized urn of claim 4, wherein the desired shape is a car.

6. The customized urn of claim 1, further comprising at least one component attached to the printed outer surface. The customized urn of claim 5, wherein the at least one component is removably attached to the printed outer surface.

8. The customized urn of claim 6, wherein the at least one component has at least one magnet and the printed outer surface has at least one magnet.

9. The customized urn of claim 1, wherein the wall thickness comprises at least a first layer defining the printed outer surface and a second layer defining the inner surface.

10. The customized urn of claim 9, wherein the second layer has a thickness greater than the first thickness.

11. The customized urn of claim 9, wherein the wall thickness comprises a third layer between the first layer and the second layer.

12. The customized urn of claim 11, wherein the third layer has a density less than a density of the second layer.

13. The customized urn of claim 1, further comprising at least one interior structure support spanning the cavity between a first portion of the inner surface and a second portion of the inner surface.

14. The customized urn of claim 1, wherein the sealing mechanism comprises a locking mechanism.

15. A method of manufacturing a customized urn, the method comprising:
obtaining a customer-provided image for a desired shape of the customized urn;
determining an outer surface, inner surface, a thickness between the outer surface and the inner surface, and cavity from the customer-provided image;
printing layers of material to form at least the outer surface and the inner surface; and
applying a hardening agent to at least one of the outer surface and the inner surface.

16. The method of claim 15, further comprising:
applying a paint layer to the outer surface.

17. The method of claim 15, further comprising:
allowing the hardening agent to cure.

18. The method of claim 15, further comprising:
removing excess hardening agent from the cavity.

19. The method of claim 18, wherein the cavity is sloped.
